(19) United States
(12) Patent Application Publication
(10) Pub. No.: US 2001/0019539 A1
(43) Pub. Date: Sep. 6, 2001

(54) Computer readable recording medium which records service-oriented DIT construction for internet protocol network service management

(75) Inventor: Hiroyuki Kawakami, Tokyo (JP)

Correspondence Address: LAFF, WHITESEL & SARET, LTD, 401 North Michigan Avenue, Chicago, IL, 60611, US

(73) Assignee: NEC Corporation

(21) Appl. No.: 09/739,158

(22) Filed: Dec. 18, 2000

(30) Foreign Application Priority Data
Dec. 27, 1999 (JP) 11-371061

(51) Int. Cl. H04L 12/28

(52) U.S. Cl. 370/256; 370/401

(57) ABSTRACT

A service-oriented DIP construction for an IP network service management is provided that can save the data capacity. Plural service entries dangle below a customer sub-tree. Plural policy rule entries dangle below each of the service entries. Plural policy rule format entries dangle below a policy sub-tree. Plural service class definition entries dangle below a system sub-tree. Each of the plural service entries includes as an attribute a condition parameter which is referred to from each policy rule entry via each policy rule format entry. Each of the plural service entries includes as an attribute an action parameter which is referred to from each policy rule entry via each policy rule format entry and via each service class definition entry.

### BACKGROUND OF THE INVENTION

The present invention relates to a service-oriented DIT (Directory Information Tree) construction, which is used in an IP (Internet Protocol) network service management system and which is recorded on the recording medium in a directory server.

Currently, the IFTF (Internet Engineering Task Force) is vigorously studying policy sub-trees.

However, the IFTF has not discuss relationships between the customer sub-tree and policy sub-tree, specifically, creation of rules based on service entries. Essentially, the customer care system is required to operate networks. Moreover, the customer care server requires a service oriented data structure (corresponding to the customer tree in the present invention). Where provisioning (setting to a NE (Network Element, specifically, a router) is intended, the policy sub-tree is needed in consideration of retrieval time, data operation, and soon. However, mapping between sub-trees has not been studied. Similarly, the scheme of reducing the data capacity has not been studied by considering both the policy sub-tree and the customer sub-tree. Various service types or changes of service definition have never been studied up to now.

### SUMMARY OF THE INVENTION

An object of the present invention is to provide a service-oriented DIT construction for an IP network service management, which can save the data capacity.

Another object of the present invention is to provide a service-oriented DIT construction for an IP network service management, which can flexibly cope with changes of rules.

Further another object of the present invention is to provide a service-oriented DIT construction for an IP network service management, which can flexibly cope with changes of services.

In order to solve the above-mentioned problems, in a computer readable recording medium according to the present invention, wherein an IP (Internet Protocol) network service oriented DIT (Directory Information Tree) construction including a customer sub-tree and a policy sub-tree is recorded, the recording medium includes mapping established between the customer sub-tree and the policy sub-tree.

Moreover, according to the present invention, a computer readable recording medium, wherein an IP (Internet Protocol) network service oriented DIT (Directory Information Tree) construction including a customer sub-tree and a policy sub-tree is recorded, comprises plural service entries dangling below the customer sub-tree; plural policy rule entries dangling below each of the service entries; plural policy rule format entries dangling below the policy sub-tree; and plural service class definition entry dangling below the system sub-tree; each of the plural service entries including as an attribute a condition parameter which is referred to from each policy rule entry via each policy rule format entry;

each of the plural service entries including as an attribute an action parameter which is referred to from each policy rule entry via each policy rule format entry and via each service class definition entry.

Moreover, in the computer readable recording medium according to the present invention, plural service entries further includes as an attribute a service type specifying a band and a packet transfer priority, the service type being the name of a specific one of the service class definition entries.

Moreover, in the computer readable recording medium according to the present invention, each of plural service entries further includes as an attribute a rule creation state indicating whether or not a policy rule entry is created below each service entry itself.

Moreover, in the computer readable recording medium according to the present invention, each of plural service entries further includes as an attribute a provisioning date/unprovisioning date which controls a policy setting/releasing operation from a policy management system.

Moreover, in the computer readable recording medium according to the present invention, each of plural service entries further includes as an attribute a network element acquired when a policy rule entry below each service entry is set.

Moreover, in the computer readable recording medium according to the present invention, each of plural service class definition entries further includes as an attribute a parameter representing a feature of a service corresponding to a service type and a pointer to a policy rule format entry to be applied to the service.

Moreover, in the computer readable recording medium according to the present invention, each of plural policy rule format entries further includes as an attribute a condition parameter and an action parameter, each to be possessed by a policy rule, and a network element to which the policy rule is applied.

Moreover, in the computer readable recording medium according to the present invention, each of plural policy rule entries further includes as an attribute a pointer to a corresponding policy rule format entry, a rule state indicating whether or not the policy rule has been applied to a network element, and a target network element specifying a network element to which the policy rule is applied.

Moreover, in the computer readable recording medium according to the present invention, the IP network service oriented DIT construction sub-tree further has network sub-trees.

An IP network service management system consists of a service oriented DIT construction for an IP service management according to the present invention, a design system (a system for designing a routing table to be stored in a router), a customer care system (a system of supporting a service acceptance to a customer and managing customer information), a policy management system (a system for managing a router according to a policy defined in a customer unit or in a service unit required by a customer), and a directory server (a server for unitarily managing data). Policy related data sets to be used by the policy management system are summarized to the service entry (stored in a directory server and including service information required by a customer) created by the customer care system. The policy related data can be acquired by referring to the service entry. This feature allows the data capacity to be saved. Moreover, the policy rule format entry 14 (FIG. 4) is used to interpret the content of the service entry as a policy rule (defined in a customer unit or service unit and described using condition and action and set to a router). This feature allows the rule to be changed flexibly. Moreover, introducing the service class definition entry 18 (FIG. 3) enables flexibly dealing with a change of service (provided to a customer). That is, when an addition or change of a service type occurs, it is not needed to change the original data service information accepted from a customer).

### BRIEF DESCRIPTION OF THE DRAWINGS

This and other objects, features and advantages of the present invention will become more apparent upon a reading of the following detailed description and drawings, in which:

FIG. 1 is a diagram illustrating a service-oriented DIT construction for art IP service management, according to an embodiment of the present invention;

FIG. 2 is a list of attributes included in a service entry according to the present invention:

FIG. 3 is a list of attributes included in a service class definition entry according to the present invention;

FIG. 4 is a list of attributes included in a policy rule format entry according to the present invention; and

FIG. 5 is a list of attributes included in a policy rule entry according to the present invention.

### DESCRIPTION OF THE EMBODIMENTS

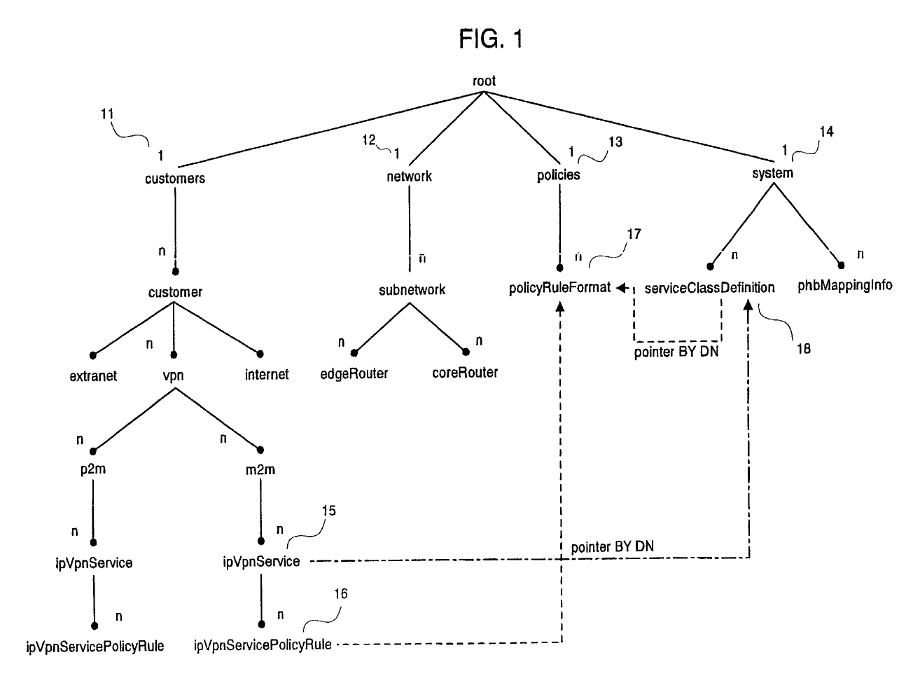

FIG. 1 depicts a DIT (Directory Information Tree) construction according to an embodiment of the present invention. The DIT construction is recorded on the recording medium such as a hard disk drive of a directory server, together with data stored in the directory server, and implements the schema definition of these sets of data. The carrier possesses the directory server, together with the system such as a design system and a policy management system.

The customers sub-tree (customer sub-tree) 11 is a sub-tree including the service entry 15 created according to a customer request when the customer care server accepts a service. For example, the service entry 15 is created by implementing the multilevel branching in a customer unit, VPN (Virtual Private Network) unit, service topology (point-to-point (P2p) unit, point-to-multipoint (p2m) unit, or a multipoint-to-multipoint (m2m)) unit. Numeral 16 represents a policy rule entry. In FIG. 1, “n” represents plural branches and is a notation according to the OMT (Object Modeling Technique). In the explanation of the pointer moving from the policy rule entry 16 to the policy rule format entry 17 and the explanation of the pointer moving from the service class definition entry 18 to the policy rule format entry 17, in FIG. 1, DN is an abbreviation of distinguished name. DN is used to uniquely specify an entry by a schema definition of LDAP (Light-weighted Directory Access Protocol).

The network sub-tree 12 is a sub-tree including a network related entry and is utilized by a network management system different from the IP service management system.

The policies sub-tree (policy sub-tree) 13 is a sub-tree including information (information residing in the entry 17) necessary for a policy management to which a QoS (Quality of Service) or security policy is applied to the IP traffic. In the embodiment, data sets of the policy rule are summed up to the service entry 15 below the customers sub-tree 11. The policies sub-tree 13 holds the policy rule format entry 17 only. The system sub-tree 14 is a sub-tree which is neutral to the customers sub-tree 11, the network sub-tree 12, and the policies sub-tree 13. In other words, the system sub-tree is the sub-tree which stores information which cannot be classified into only the customers sub-tree 11, the network sub-tree 12, and the policies sub-tree 13 but are related to all sub-trees. The system sub-tree 14 has the service class definition entry 18 below it.

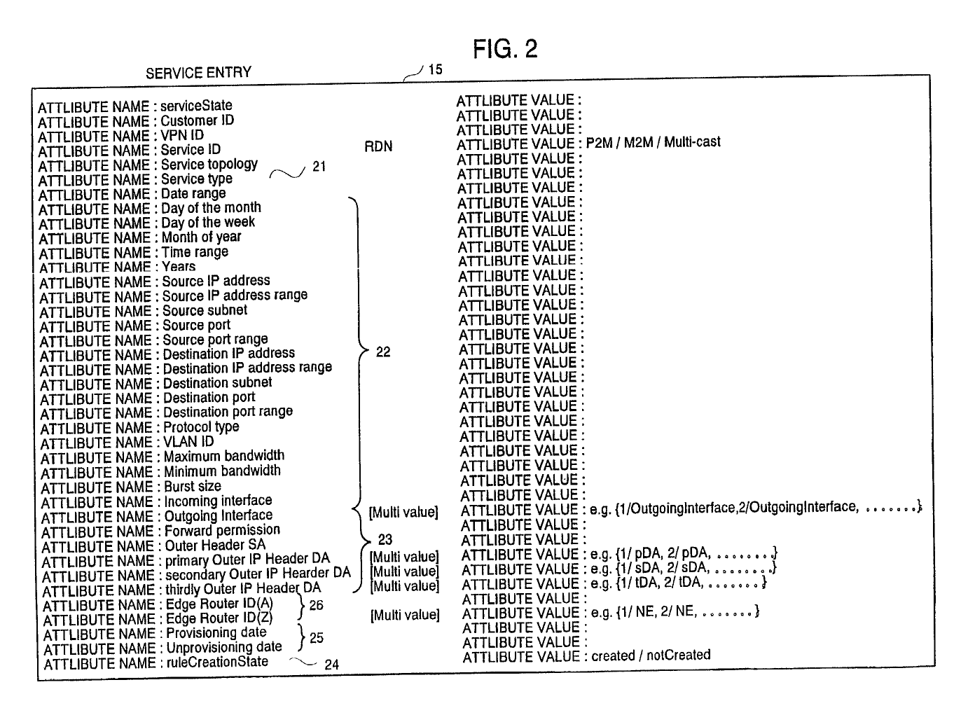

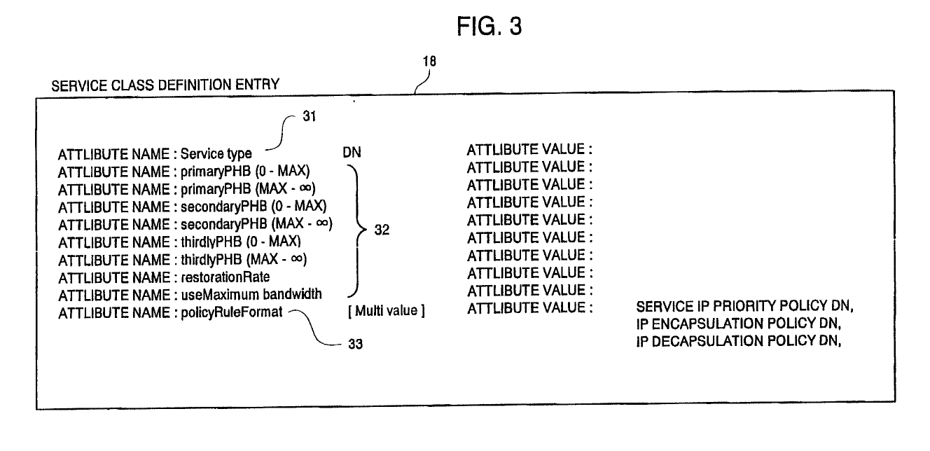

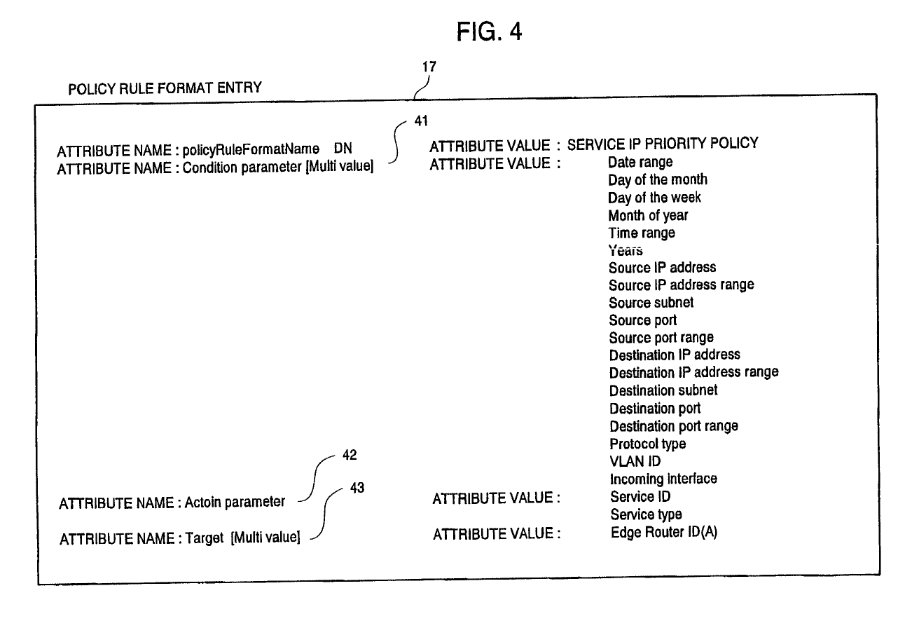

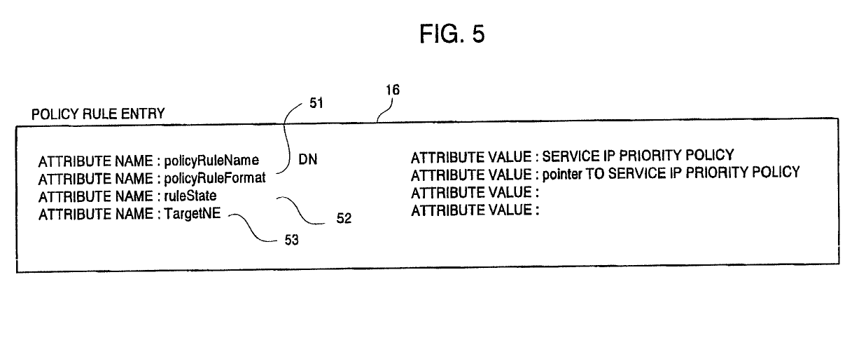

FIG. 2 is a list showing attributes possessed by the service entry 15. The service type 21 specifies a band and a packet transfer priority. The name of one of plural service class definition entries 18 (FIG. 3) is used as an attribute value (shown with the arrow extending from the service entry 15 to the service class definition entry 18 in FIG. 1). The parameter 22 is the condition parameter having the possibility that it may be used as the condition of the policy entry 16. That is, the condition parameter 22 is referred to according to the type of policy entry, based on the attribute value of the condition parameter 41 existing in the policy rule format 17 (FIG. 4) corresponding to the policy rule entry. When attention is paid to a certain policy rule entry 16 (FIG. 5), the policy rule entry 16 can refer to an attribute within the service entry because it has the attribute “policy rule format”. In this operation, the policy rule entry 16 refers to the policy rule format 17 corresponding to the policy rule entry 16 distinguished by referring to the attribute “policy rule format” (as shown with the arrow extending from the policy rule format 16 to the policy rule format entry 17) and then refers to the attribute value of the condition parameter 41 possessed by the policy rule format 17 is referred. This reference method allows the data capacity to be saved.

Numeral 23 represents part of the action parameter of a policy rule. There is as another action parameter PHB (per Hop Behavior) possessed by the service class definition entry. These parameters are related to each other as follows:

In the operation procedure, it is assumed that a service entry is first created and that a policy rule entry is next created and that the content of the policy rule is finally set to a router.

First, the service class definition entry is retrieved based on the service type information held by the service entry. The service class definition entry has PHB to its service class and a policy rule format entry. Next, a policy rule entry is created according to the policy rule format.

The policy rule entry, which has policy rule format information, can retrieve the action parameter 23 with PHB and Service ID as an action parameter, based on the service type information possessed by the policy rule format.

In the above operation, all action parameters can be prepared with data capacity saved and with flexible measures against changes in service class definition.

The ruleCreationsState (rule creation state) 24 is the attribute for representing whether or not the policy rule entry 16 (FIG. 15) that the policy management system uses to set a policy to the router has been created, based on the service entry 15 (FIG. 2). Plural policy rule entries 16 are created in a batch mode to one service entry 15. As to the service entry in which RuleCreationState 24 has a value of “non-creation”, the policy management system creates the policy rule entry 16 (FIG. 5) below the service entry 15, based on the service entry 15 (FIG. 2) and the service format entry policy 17 (FIG. 4).

Provisioning date/unprovisioning date 25 controls the policy setting/setting releasing (provisioning/unprovisioning) operation from the policy management system and is associated with services provided to customers. That is, the provisioning date/unprovisioning date 25 is determined and input by the policy determined by a carrier (e.g. to complete the provisioning one day in advance of a service), based on the service period (such as Years in a Date range) during which a customer requests.

Numeral 26 represents the service entry, that is, the entry obtained by setting an object NE (network element corresponding to a router) when a policy rule entry created from the service entry is set.

Referring to FIG. 2, RDN is an abbreviation of relative distinguished name. P2M is an abbreviation of point to point multipoint. M2M is an abbreviation of multi point to multipoint. pDA is an abbreviation of primary destination address (current routing address). sDA is an abbreviation of secondary destination address (alternate routing address). NE is an abbreviation of network element.

FIG. 3 is a list showing a service definition entry. Each of attributes 32 shows the feature of a service corresponding to a service type. Each of the attributes 33 is a pointer to a policy rule format to be applied to the service.

FIG. 4 is a list showing a policy rule format entry. Condition parameter 41 represents a condition parameter to be possessed by the policy rule. Action parameter 42 represents an action parameter to be possessed by the rule. Target 43 specifies a network element being an object to which the rule is applied. One or more attributes 26 of the service entry 15 enters target 43 contains.

FIG. 5 is a list showing a policy rule entry 16. The policy management system sets a policy to the network element NE based on the policy rule Entry. PolicyRuleFormat 51 is a pointer to the policy rule format entry 17 representing the format of the rule. That is, the content of the condition parameter and the content of the action parameter, possessed by the policy rule, can be retrieved by referring to the policy rule format entry 17. RuleState (rule state) 52 represents whether or not the rule has been set to the network element (NE). target NE (target network element) 53 specifies a network element being a device object to which the rule is applied. One or more attributes 26 of the service entry 15 enter the target NE 53.

The operation of the recording medium according to the present invention will be described below referring to FIGS. 1 to 5. First, when the customer care system accepts a service, the service entry 15 is created based on the service definition entry 18 corresponding to a requested service. The condition parameter group 22, the provisioning Date/Unprovisioning date 25, the Edge router ID(A), and the Edge router ID(B) 26 are created based on the information at the time of service acceptance. Next, the design server of a design system calculates part of the action parameter 23 and writes it into the service entry 15. Thereafter, the status value serviceState possessed by the service entry is set to “planned”. Moreover, to create the service rule entry needed by the policy management system, ruleCreationState 24 is set to “Not created” at the time the service entry 15 is newly created or changed.

Next, the policy management system retrieves the service entry 15 for creating a rule, based on the serviceState and ruleCreationStaste 24, thus implementing the policy rule creation. The policy rule to be created is revealed based on the attribute value, service type 21, of the service entry 15 and the service definition entry 18 corresponding to the service type 21. Target NE 53 can be solved by referring to edge router ID 26 and target 43.

In the above-mentioned operation, a change of the service definition can be dealt with by changing the service definition entry only.

In the above-mentioned operation, when types of the format of a rule, for example, of the condition parameter 22 are decreased, such a state can be coped with by changing the policy rule format entry only within the directory.

The present invention can be utilized to the DIT construction definition for the directory server, without being restricted to IP-VPN, to reduce the data capacity and to cope with flexibly to changes.

As described above, the present invention can provide the following advantages.

Policy related data utilized by the policy management system are collected to service entries created by the customer care system. Thus, the data capacity of the policy related data can be saved by referring to the service entry.

Moreover, by using the format entry interpreted as a policy rule, the content of each service entry can be flexibly coped with changes of rules.

Moreover, introducing the service definition entry enables flexibly coping with service changes.

The entire disclosure of Japanese Patent Application No. 11-371061 filed on Dec. 27, 1999 including specification, claims, drawing and summary are incorporated herein by reference in its entirety.

What is claimed is:

1. A computer readable recording medium, wherein an IP (Internet Protocol) network service oriented DIT (Directory Information Tree) construction including a customer sub-tree and a policy sub-tree is recorded, said recording medium including mapping established between said customer sub-tree and said policy sub-tree.

2. The computer readable recording medium defined in claim 1, wherein said IP network oriented DIT construction sub-tree further has network sub-trees.

3. A computer readable recording medium, wherein an IP (Internet Protocol) network service oriented DIT (Directory Information Tree) construction including a customer sub-tree and a policy sub-tree is recorded, comprising:
plural service entries dangling below said customer sub-tree;
plural policy rule entries dangling below each of said service entries;
plural policy rule format entries dangling below said policy sub-tree; and
plural service class definition entry dangling below said system sub-tree;
each of said plural service entries including as an attribute a condition parameter which is referred to from each policy rule entry via each policy rule format entry;
each of said plural service entries including as an attribute an action parameter which is referred to from each policy rule entry via each policy rule format entry and via each service class definition entry.

4. The computer readable recording medium defined in claim 4, wherein each of said plural service entries further includes as an attribute a service type specifying a band and a packet transfer priority, said service type being the name of a specific one of said service class definition entries.

5. The computer readable recording medium defined in claim 4, wherein each of said plural service entries further includes as an attribute a rule creation state indicating whether or not a policy rule entry is created below each service entry itself.

6. The computer readable recording medium defined in claim 4, wherein each of said plural service entries further includes as an attribute a provisioning date/unprovisioning date which controls a policy setting/releasing operation from a policy management system.

7. The computer readable recording medium defined in claim 4, wherein each of said plural service entries further includes as an attribute a network element acquired when a policy rule entry below each service entry is set.

8. The computer readable recording medium defined in claim 4, wherein each of said plural service class definition entries further includes as an attribute a parameter representing a feature of a service corresponding to a service type and a pointer to a policy rule format entry to be applied to said service.

9. The computer readable recording medium defined in claim 4, wherein each of said plural policy rule format entries further includes as an attribute a condition parameter and an action parameter, each to be possessed by a policy rule, and a network element to which said policy rule is applied.

10. The computer readable recording medium defined in claim 4, wherein each of said plural policy rule entries further includes as an attribute a pointer to a corresponding policy rule format entry, a rule state indicating whether or not said policy rule has been applied to a network element, and a target network element specifying a network element to which said policy rule is applied.

11. The computer readable recording medium defined in claim 4, wherein said IP network oriented DIT construction sub-tree further has network sub-trees.

12. The computer readable recording medium defined in claim 3, wherein each of said plural service entries further includes as an attribute a rule creation state indicating whether or not a policy rule entry is created below each service entry itself.

13. The computer readable recording medium defined in claim 12, wherein each of said plural service entries further includes as an attribute a provisioning date/unprovisioning date which controls a policy setting/releasing operation from a policy management system.

14. The computer readable recording medium defined in claim 12, wherein each of said plural service entries further includes as an attribute a network element acquired when a policy rule entry below each service entry is set.

15. The computer readable recording medium defined in claim 12, wherein each of said plural service class definition entries further includes as an attribute a parameter representing a feature of a service corresponding to a service type and a pointer to a policy rule format entry to be applied to said service.

16. The computer readable recording medium defined in claim 12, wherein each of said plural policy rule format entries further includes as an attribute a condition parameter and an action parameter, each to be possessed by a policy rule, and a network element to which said policy rule is applied.

17. The computer readable recording medium defined in claim 12, wherein each of said plural policy rule entries further includes as an attribute a pointer to a corresponding policy rule format entry, a rule state indicating whether or not said policy rule has been applied to a network element, and a target network element specifying a network element to which said policy rule is applied.

18. The computer readable recording medium defined in claim 12, wherein said IP network oriented DIT construction sub-tree further has network sub-trees.

19. The computer readable recording medium defined in claim 3, wherein each of said plural service entries further includes as an attribute a provisioning date/unprovisioning date which controls a policy setting/releasing operation from a policy management system.

20. The computer readable recording medium defined in claim 19, wherein each of said plural service entries further includes as an attribute a network element acquired when a policy rule entry below each service entry is set.

21. The computer readable recording medium defined in claim 19, wherein each of said plural service class definition entries further includes as an attribute a parameter representing a feature of a service corresponding to a service type and a pointer to a policy rule format entry to be applied to said service.

22. The computer readable recording medium defined in claim 19, wherein each of said plural policy rule format entries further includes as an attribute a condition parameter and an action parameter, each to be possessed by a policy rule, and a network element to which said policy rule is applied.

23. The computer readable recording medium defined in claim 19, wherein each of said plural policy rule entries further includes as an attribute a pointer to a corresponding policy rule format entry, a rule state indicating whether or not said policy rule has been applied to a network element, and a target network element specifying a network element to which said policy rule is applied.

24. The computer readable recording medium defined in claim 19, wherein said IP network oriented DIT construction sub-tree further has network sub-trees.

25. The computer readable recording medium defined in claim 3, wherein each of said plural service entries further includes as an attribute a network element acquired when a policy rule entry below each service entry is set.

26. The computer readable recording medium defined in claim 25, wherein each of said plural service class definition entries further includes as an attribute a parameter representing a feature of a service corresponding to a service type and a pointer to a policy rule format entry to be applied to said service.

27. The computer readable recording medium defined in claim 25, wherein each of said plural policy rule format entries further includes as an attribute a condition parameter and an action parameter, each to be possessed by a policy rule, and a network element to which said policy rule is applied.

28. The computer readable recording medium defined in claim 25, wherein each of said plural policy rule entries further includes as an attribute a pointer to a corresponding policy rule format entry, a rule state indicating whether or not said policy rule has been applied to a network element, and a target network element specifying a network element to which said policy rule is applied.

29. The computer readable recording medium defined in claim 25, wherein said IP network oriented DIT construction sub-tree further has network sub-trees.

30. The computer readable recording medium defined in claim 3, wherein each of said plural service class definition entries further includes as: an attribute a parameter representing a feature of a service corresponding to a service type and a pointer to a policy rule format entry to be applied to said service.

31. The computer readable recording medium defined in claim 30, wherein each of said plural policy rule format entries further includes as an attribute a condition parameter and an action parameter, each to be possessed by a policy rule, and a network element to which said policy rule is applied.

32. The computer readable recording medium defined in claim 30, wherein each of said plural policy rule entries further includes as an attribute a pointer to a corresponding policy rule format entry, a rule state indicating whether or not said policy rule has been applied to a network element, and a target network element specifying a network element to which said policy rule is applied.

33. The computer readable recording medium defined in claim 30, wherein said IP network oriented DIT construction sub-tree further has network sub-trees.

34. The computer readable recording medium defined in claim 3, wherein each of said plural policy rule format entries further includes as an attribute a condition parameter and an action parameter, each to be possessed by a policy rule, and a network element to which said policy rule is applied.

35. The computer readable recording medium defined in claim 34, wherein each of said plural policy rule entries further includes as an attribute a pointer to a corresponding policy rule format entry, a rule state indicating whether or not said policy rule has been applied to a network element, and a target network element specifying a network element to which said policy rule is applied.

36. The computer readable recording medium defined in claim 34, wherein said IP network oriented DIT construction sub-tree further has network sub-trees.

37. The computer readable recording medium defined in claim 3, wherein each of said plural policy rule entries further includes as an attribute a pointer to a corresponding policy rule format entry, a rule state indicating whether or not said policy rule has been applied to a network element, and a target network element specifying a network element to which said policy rule is applied.

38. The computer readable recording medium defined in claim 37, wherein said IP network oriented DIT construction sub-tree further has network sub-trees.

39. The computer readable recording medium defined in claim 3, wherein said IP network oriented DIT construction sub-tree further has network sub-trees.
